(19) United States
(12) Patent Application Publication
(10) Pub. No.: US 2012/0182375 A1
(43) Pub. Date: Jul. 19, 2012

(54) METHOD FOR LASER MARKING AND LASER MARKING SYSTEM

(75) Inventors: Abolghasem Shourvarzi, Malmo (SE); Cecilia Börjesson, Malmo (SE)

(73) Assignee: Tetra Laval Holdings & Finance S.A., Pully (CH)

(21) Appl. No.: 13/497,887

(22) PCT Filed: Sep. 23, 2010
(86) PCT No.: PCT/EP10/05818

§ 371 Date: Mar. 23, 2012

(30) Foreign Application Priority Data
Sep. 23, 2009 (SE) 0901232-9

(51) Int. Cl. B41J 2/47

(52) U.S. Cl. 347/225

(57) ABSTRACT

A method for laser marking a substrate provided with a laser sensitive area using a laser, wherein the laser sensitive area is adapted to be activated at a threshold energy level, the method comprising: energizing the laser sensitive area by an energizing element irradiating the complete laser sensitive area, and exposing a portion of the laser sensitive area to irradiation from the laser, wherein the energizing element is configured to emit radiation being concentrated at a specific wavelength, and wherein the combined irradiation results in an energy passing the threshold energy level such that the laser sensitive area is activated at the portion where combined irradiation has occurred. The invention is also related to a laser marking system for carrying out the method.

### TECHNICAL FIELD

The present invention relates to a method for laser marking and a laser marking system.

### TECHNICAL BACKGROUND

There are different ways of marking substrates, such as for example packaging material, with alphanumerical numbers or codes, two dimensional codes, symbols, text, images etc. One way is to use laser technology; i.e. to use a laser and laser sensitive inks, coatings or pigments. Hereinafter such technology is denoted “laser marking”.

The published document SE 0800601 describes laser marking of a packaging material with a core layer of paper or paper board.

Laser sensitive ink or coating, hereinafter denoted “ink”, is a mix of laser light absorbers and colour formers. Upon exposure of laser light the light absorbers in the ink absorb the photon energies and create heat, which heat ignites the colour formers changing their colour.

A substrate such as a packaging material may be provided with a laser sensitive area, i.e. an area provided with such laser sensitive ink, coating or pigment, and the marking equipment, being a laser, may provide a print or marking unique to each portion of the packaging material and/or a print that can be instantly changed.

Preferably, the marker or marking equipment needs to be able to perform printing at very high speeds and with high resolution. Today there are filling machines running a packaging material web at a speed of 1.2 meters per second.

Different laser marking systems are present on the market. However, the systems are too slow or give too low resolution. For high speed marking with high resolution a laser diode array seems to be the best option. However, present laser diode arrays on the market are low energy lasers with an effect around or lower than 0.5 Watts. These have proven to be insufficient. It has been realized that the power is not enough to do marking at a speed higher than 1 meter per second.

Further, lasers, except laser diode array, need reflection equipment such as for example a Galvanometer scanner. Such equipment also limits the marking speed and resolution. Presently, a system including a Galvanometer scanner is not applicable for marking at such high speed as 1.2 meters per second.

Today there are not any high energy laser diode arrays (lasers with an effect above 0.5 Watts) available on the market. A laser diode array could be turned into a high energy laser, but it will only provide low resolution since the diodes may not be mounted sufficiently close to each other in a monolithic array. Another difficulty is the cooling system of such a laser.

### SUMMARY

The object of the invention is therefore to provide a method for laser marking a substrate provided with a laser sensitive area, said laser sensitive area being adapted to be activated at a threshold energy level, using a low energy laser. The method provides a possibility of being able to mark at high speed with high resolution. The method comprises the steps of energizing said laser sensitive area by an energizing element irradiating the complete laser sensitive area, and exposing a portion of said laser sensitive area to irradiation from said laser, wherein the energizing element is configured to emit radiation being concentrated at a specific wavelength, and wherein the combined irradiation results in an energy passing said threshold energy level such that the laser sensitive area is activated at the portion where combined irradiation has occurred.

The inventive method is further defined in the dependent claims 2-8.

The invention also relates to laser marking system.

The laser marking system is further defined in the dependent claims 10-16.

### BRIEF DESCRIPTION OF THE DRAWINGS

An embodiment will be described in more detail with reference to the enclosed drawings, in which

FIG. 1 is a schematic figure showing the energy levels according to the invention, and

FIG. 2 is a schematic figure showing a presently preferred embodiment.

### DESCRIPTION OF AN EMBODIMENT

As initially mentioned a laser sensitive ink or coating, hereinafter denoted “ink”, is generally a mix of laser light absorbers and colour formers. Upon exposure of laser light the light absorbers in the ink absorb the photon energies and create heat, which heat ignites or activates the colour formers changing their colour. In this way a marking may be made on a substrate.

Some laser sensitive inks are thermo sensitive, being activated by heat, and some are wavelength sensitive, being activated if being exposed to a certain wavelength. In this description the term “irradiation” will be used, and it is to be understood that this term encompasses both irradiation in the form of heat radiation and irradiation in the form of wavelength-specific radiation, depending on the source that provides the irradiation.

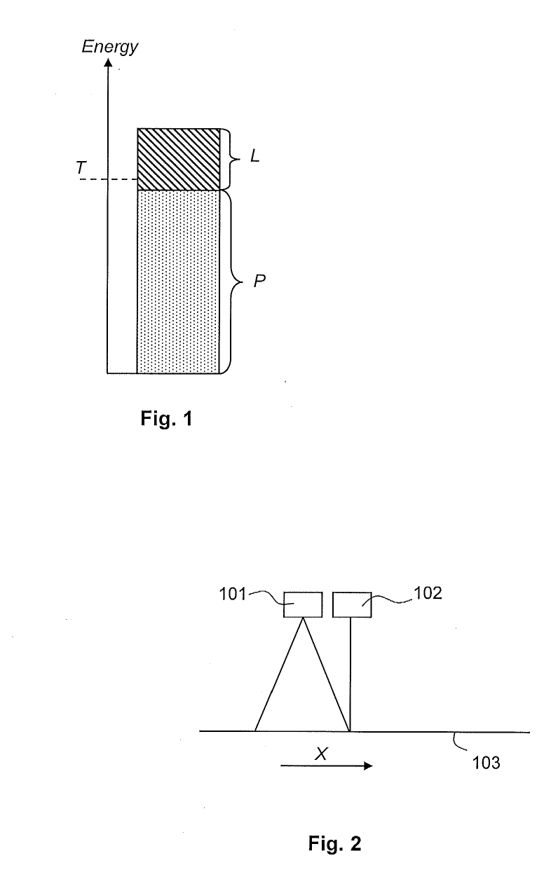

A certain amount of energy is needed to activate the ink, i.e. make the ink change colour. FIG. 1, illustrating the basic principle, shows the energy provided to a laser sensitive area of a substrate. Preferably, the substrate also comprises an area not being sensitive to laser radiation, such that the laser marking may be provided on a specific and predetermined area of the substrate. The colour change will start taking place at a threshold level denoted T. In for example a high speed filling machine, operating at a packaging material web speed of up to about 1.2 meters per second, it has been found difficult to provide the necessary energy using today's low energy lasers.

In the method of the invention this is solved by the steps of energizing the laser sensitive area by irradiation with an energizing element, and exposing said laser sensitive area to irradiation from the laser. The combined irradiation results in an energy passing the threshold energy level T such that the laser sensitive area is activated where combined irradiation has occurred.

In the embodiment shown in FIG. 1 the laser sensitive area is pre-energized up to an energy level being less than the threshold energy level T. This means that the laser sensitive ink is “pre-loaded” with a major part of the necessary energy. However, the entire sensitive area will be energized, not only the points to be marked, so it is preferred not to provide energy all the way up to the threshold level T, but to keep a margin towards that level.

After the pre-energizing step, the laser sensitive area may be exposed to radiation from a laser to make the actual marking. Thus, the laser will provide the rest of the energy needed to at least pass the threshold energy level T, that is, to activate the laser sensitive area. This amount of energy is represented by L in FIG. 1. This energy will only be exposed to those points in the laser sensitive area where colour change is desired, that is, where marking should be made. The laser provides enough energy to pass the threshold energy level T, preferably enough to pass the level with a considerable margin to ascertain that a colour change will take place and that a desired contrast between the mark and the background has been reached.

The energy absorbed in the laser sensitive area of the substrate in the pre-energizing step does not stay in the material, but is quickly disappearing. Therefore, it is advantageous if the pre-energizing is made immediately before the substrate is exposed to the laser.

Using the method of the invention several types of lasers may be used to create high speed and high resolution marking. One type of laser that may be used is the near infrared, for example a laser diode array, a fibre coupled diode array, or a fibre laser. A laser diode array, being made of several diodes close together, may be working in the wavelength range of 650-5500 nm. Further, a CO₂ laser may instead be used as well as a Nd:YAG laser.

According to the method the step of energizing is made by an energizing element. The energizing may for example be made by any of the following: infrared radiation source, or a laser. Also other energizing sources are possible, such for example hot air or hot fluid. One aspect when choosing energizing element is that the energy should preferably be homogenously spread on the laser sensitive area. Another aspect is the possibility of controlling the amount of energy provided from the energizing element so that the threshold energy level T is not accidently exceeded. Overall, the energizing element should be chosen with regard to the composition of the laser sensitive ink and the structure and sensitivity of the substrate to be energized. If a wavelength sensitive ink is used the source is preferably a wide laser beam or an infrared light source.

In one preferred embodiment an infrared light source may be used as energizing element. Such infrared light source may provide electromagnetic radiation in a narrow frequency interval, wherein the main part of the emitted energy is concentrated at a peak wavelength. For example, a commercially available IR light emitting diode has a peak wavelength of 2.6 microns, and the energy is distributed according to a Gaussian profile between 1.9 and 3.3 microns. Other infrared light sources are also known in the art, which are designed to have different peak wavelengths and different FWHM.

Infrared heating is the transfer of thermal energy in the form of electromagnetic waves. A hot source, for example a quartz lamp, quartz tube or metal rod, will generate the electromagnetic radiation by vibration and rotation of molecules. The source emits radiation at a peak wavelength towards an object. The object can absorb the radiation at some wavelength and reflect or re-radiate radiation at other wavelengths. It is the absorbed radiation that creates the heat within the object. The efficiency of this type of heaters may be more than 80%. Infrared heating varies by efficiency, wavelength and reflectivity. These characteristics set them apart and make some of them more effective for certain applications than others. The useful range of wavelengths for infrared heating applications fall within the range of 0.7-10 micrometers (μm) of the electromagnetic spectrum and is divided into three groups: short wavelength (0.72-1.5 μm), medium wavelength (1.5-5.6 μm) and long wavelength (5.6-10 μm). It has been found that a short and medium wavelength infrared source could suitably be combined with a diode array laser and a fibre coupled diode array laser, the latter emitting radiation at a wavelength in the range of 0.65-5.6 micrometer (μm).

Laser sensitive ink has been described. However, it should be understood that the laser sensitiveness, provided in the laser sensitive areas, does not need to be provided by means of application of an ink or coating. The laser sensitive areas may be provided by means of application of laser sensitive pigments in the substrate. In an example with a packaging material laminate having a core of paper or paper board and outer layers of polymer, the laser sensitive ink or coating may be provided so that it is protected by the outermost polymer layer. In the case of pigments, the pigments may instead be embedded in the protective polymer layer of the packaging laminate. Hence, in both examples the laser sensitive area is protected by a polymer layer. Such embodiments are further advantageous in that the energizing element may be chosen such that the peak emitted wavelength of the IR source is transmitted through the polymer layer without being absorbed. Hence, there will be no or very little heat dissipation in the polymer layer, and the main part of the emitted energy will be absorbed by the active component of the laser sensitive area. Consequently, it may be preferred to match the peak wavelength of the energizing element with the wavelength required to activate or ignite the active component of the laser sensitive ink, as well as to the transmission spectrum of the protective polymer layer. This specific embodiment contributes to an overall decrease of energy used to mark the substrate.

For example, if the protective polymer layer is made of LDPE such layer has increased absorption at e.g. approximately 3-3.5 microns. Hence, those wavelengths should be avoided when choosing the required equipment, including the laser sensitive ink. The same is valid if the protective layer is made of polypropylene.

According to a specific embodiment, a method for laser marking a substrate using a laser 102 is provided. The substrate 103 is provided with a laser sensitive area being protected by a polymer layer having a significant absorbance at least at one wavelength, said laser sensitive area being adapted to be activated at a threshold energy level T. The method comprises the steps of:
energizing said laser sensitive area by an energizing element 101 irradiating the complete laser sensitive area, and
exposing a portion of said laser sensitive area to irradiation from said laser 102,
wherein the energizing element is configured to emit radiation being concentrated at a specific wavelength, said specific wavelength being different from the absorbance wavelength of the protective layer, and wherein the combined irradiation results in an energy passing said threshold energy level T such that the laser sensitive area is activated at the portion where combined irradiation has occurred.

The specific emission wavelength of the energizing element may be close or equal to the emission wavelength of the laser. The term “close” should in this context be interpreted as the emitted radiation of the energizing element is to some extent overlapping the emission wavelength of the laser.

The invention also comprises a laser marking system for laser marking a substrate provided with a laser sensitive area. The system is schematically shown in FIG. 2. The system is designed to carry out the previously described method and will not be described in detail. Reference is made to the description of the method.

An embodiment of the system briefly comprises an energizing element 101 for pre-energizing the laser sensitive area up to an energy level being less than the threshold energy level T. Further, the system comprises a laser 102 able to provide the rest of the energy needed to at least pass the threshold energy level Tin order to activate the laser sensitive area.

The energizing element 101 and the laser 102 are located so in relation to each other that a substrate 103, for example a packaging material web, is passing the energizing element 101 immediately before passing the laser 102. The moving direction of the web is represented by the arrow X.

In the following, two different experiments will be described as examples of a laser marking method according to some embodiments. In both setups, an IR halogen lamp having a peak emission wavelength at 1000 nm was used as an energizing element, and a laser operating at 1070 nm was used in the marking system. Two different laser sensitive inks were used, both being activated by absorbing radiation at 1070 nm. The activation is indicated by a change in colour from transparent to black. Both experiments were made with reference to a background measurement, wherein the optical density was measured without the use of the IR halogen lamp.

### EXAMPLE 1

An area of 8*7 mm of a substrate was coated with ink A. The laser energy density was set to 1.4 and 2.0 J/cm2, respectively, and the power density of the IR halogen lamp was set to 0.79 W/cm2. The optical density was then measured versus IR exposure time for the different laser energy densities. The test results indicated that utilizing a laser energy density of 1.4 J/cm2 together with the IR energizing element ands optical density of 0.6 was obtained. This corresponds to the use of a background laser energy density of 2.6 J/cm2, i.e. a decrease of 46% of laser energy needed for marking.

Further, the test results indicated that utilizing a laser energy density of 2.0 J/cm2 together with the IR energizing element ands optical density of 0.75 was obtained. This corresponds to the use of a background laser energy density of 2.8 J/cm2, i.e. a decrease of 29% of laser energy needed for marking.

### EXAMPLE 2

An area of 8*7 mm of a substrate was coated with ink B. The laser energy density was set to 0.38 and 0.6 J/cm2, respectively, and the power density of the IR halogen lamp was set to 0.79 W/cm2. The optical density was then measured versus IR exposure time for the different laser energy densities. The test results indicated that utilizing a laser energy density of 0.38 J/cm2 together with the IR energizing element ands optical density of 1.0 was obtained. This corresponds to the use of a background laser energy density of 0.6 J/cm2, i.e. a decrease of 36% of laser energy needed for marking.

Further, the test results indicated that utilizing a laser energy density of 0.6 J/cm2 together with the IR energizing element ands optical density of 2.2 was obtained. This corresponds to the use of a background laser energy density of 1.4 J/cm2, i.e. a decrease of 57% of laser energy needed for marking.

Although the present invention has been described with respect to a presently preferred embodiment, it is to be understood that various modifications and changes may be made without departing from the object and scope of the invention as defined in the appended claims.

It has been described that the step of energizing with the energizing element 101 is made before the substrate 103 is exposed to the laser 102. However, it should be understood that the step of energizing with the energizing element 101 may instead be made after the substrate 103 is exposed to the laser 102. This may be illustrated by reversing the arrow X in FIG. 2 so that the substrate 103 is moving in the opposite direction. Another alternative is that both the energizing element 101 and the laser 102 irradiate the laser sensitive area at the same time, or that the irradiation from each respective source is at least partly overlapping each other in time. The laser marking system may of course be correspondingly modified.

In the embodiment it has been described that the substrate is a packaging material web. It can of course be any other type of object such as for example a package, a pallet, a secondary package, a family pack (comprising several packages) or any other type of product. In that perspective the laser sensitive area might be arranged as a patch or by other suitable means.

Further, it has been described that the substrate is running and that the marking is made on the fly. Of course the substrate to be marked may instead be stationary, moved in slow speed or moved by indexing a step at a time.

1-14. (canceled)

15. A method for laser marking a substrate provided with a laser sensitive area using a laser, the laser sensitive area comprising laser sensitive ink or coating or pigments and being adapted to be activated at a threshold energy level, the method comprising:
energizing the laser sensitive area by an energizing element irradiating the complete laser sensitive area, and
exposing a portion of the laser sensitive area to irradiation from the laser,
wherein the energizing element is configured to emit radiation concentrated at a specific wavelength, and wherein the combined irradiation results in an energy passing the threshold energy level such that the laser sensitive area is activated at the portion where combined irradiation has occurred.

16. Method according to claim 15, wherein the energizing with the energizing element is performed before the substrate is exposed to the laser.

17. Method according to claim 15, wherein the laser is a near infrared type laser.

18. Method according to claim 17, wherein the laser is a diode array laser.

19. Method according to claim 17, wherein the laser is a fibre laser.

20. Method according to claim 15, wherein the energizing element is an infrared radiation source or a laser beam.

21. Method according to claim 20, wherein the energizing is made by an infrared radiation source which emits radiation at a wavelength in a range of 0.65-5.6 micrometer (μm) and wherein the laser emits radiation at a wavelength in a range of 0.65-5.6 micrometer (μm).

22. A laser marking system for laser marking a substrate provided with a laser sensitive area, the laser sensitive area comprising laser sensitive ink or coating or pigments and being adapted to be activated at a threshold energy level, the system comprising
an energizing element adapted to irradiate the complete laser sensitive area, and
a laser adapted to irradiate a portion of the laser sensitive area, wherein the combined irradiation results in an energy passing the threshold energy level such that the laser sensitive area is activated at the portion where combined irradiation has occurred.

23. Laser marking system according to claim 22, wherein the laser is a near infrared type laser.

24. Laser marking system according to claim 22, wherein the laser is a diode array laser.

25. Laser marking system according to claim 22, wherein the laser is a fibre laser or a fibre coupled diode array laser.

26. Laser marking system according to claim 22, wherein the energizing element is one of an infrared light source, a laser beam, a flash lamp, hot air or hot liquid.

27. Laser marking system according to claim 22, wherein the substrate is a packaging material web provided to pass the lasermaking system at a speed in the range of 0.2-15 meters per second.

28. Laser marking system according to claim 22, wherein the energizing element and the laser are located in relation to each other so that the substrate passes the energizing element before passing the laser.
